(19) United States
(12) Patent Application Publication
(10) Pub. No.: US 2011/0271248 A1
(43) Pub. Date: Nov. 3, 2011

(54) CONVERTING CONTROLS INTO SOURCE CODE

(75) Inventor: Iouri B. Simernitski, Redmond, WA (US)

(73) Assignee: Microsoft Corporation, Redmond, WA (US)

(21) Appl. No.: 12/769,674

(22) Filed: Apr. 29, 2010

(51) Int. Cl. G06F 9/44; G06F 9/45

(52) U.S. Cl. 717/108; 717/109; 717/106; 717/140

(57) ABSTRACT

Aspects of the subject matter described herein relate to converting controls into source code. In aspects, a control is created via a designer. The control may include properties, code, and a visual representation. The control may be represented at least in part via a markup language. At one or more times during or after development of a software project, source code for the control may be generated, transformed, and placed into the project. This may be done, among other reasons, to simplify software development.

### BACKGROUND

A complex set of interactions may occur in conjunction with browsing to a Web page. A client such as an Internet browser may contact a server such as a Web server and request code corresponding to the Web page. In response, the server may locate server code corresponding to the Web page and use the server code to generate client code to send to the client. Some of the client code may include instructions for displaying static text and graphics on a display of the client. Other of the client code may include executable instructions for the client to execute to display an interactive control or the like on the display of the client. Creating tools that allow a software developer to seamlessly create the server code corresponding to a Web page is challenging.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to converting controls into source code. In aspects, a control is created via a designer. The control may include properties, code, and a visual representation. The control may be represented at least in part via a markup language. At one or more times during or after development of a software project, source code for the control may be generated, transformed, and placed into the project. This may be done, among other reasons, to simplify software development.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that generally represents an exemplary environment in which aspects of the subject matter described herein may be implemented;

FIG. 3 is a block diagram that represents an apparatus configured to operate as a software development platform in accordance with aspects of the subject matter described herein; and

FIGS. 4-5 are flow diagrams that generally represent actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.” Other definitions, explicit and implicit, may be included below.

### Exemplary Operating Environment

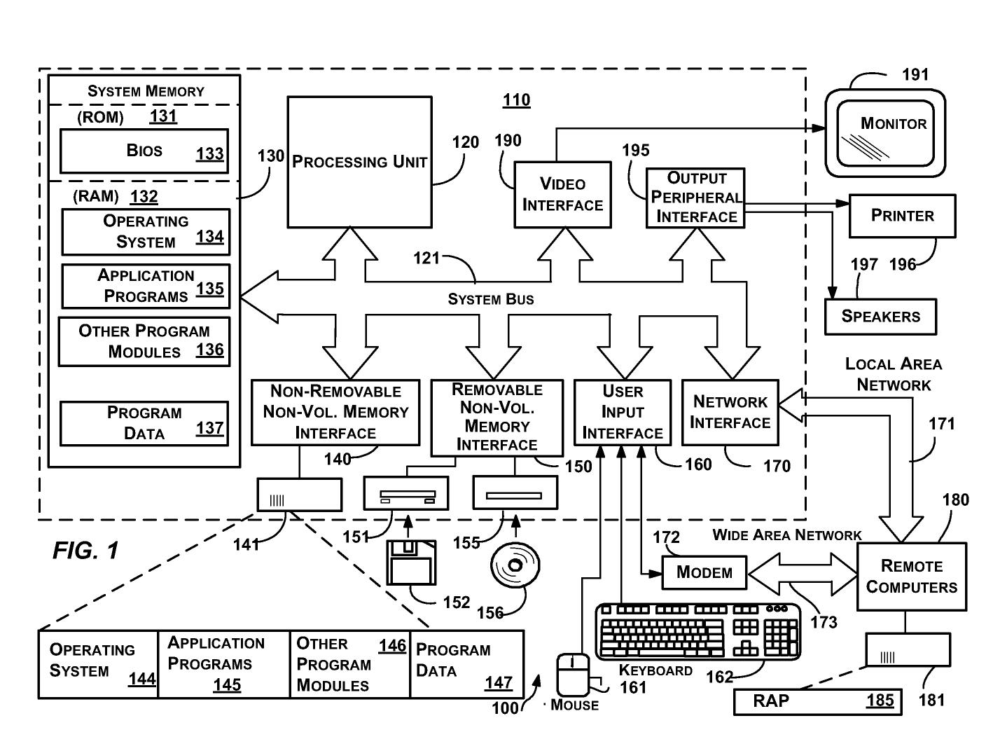

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Developing Software

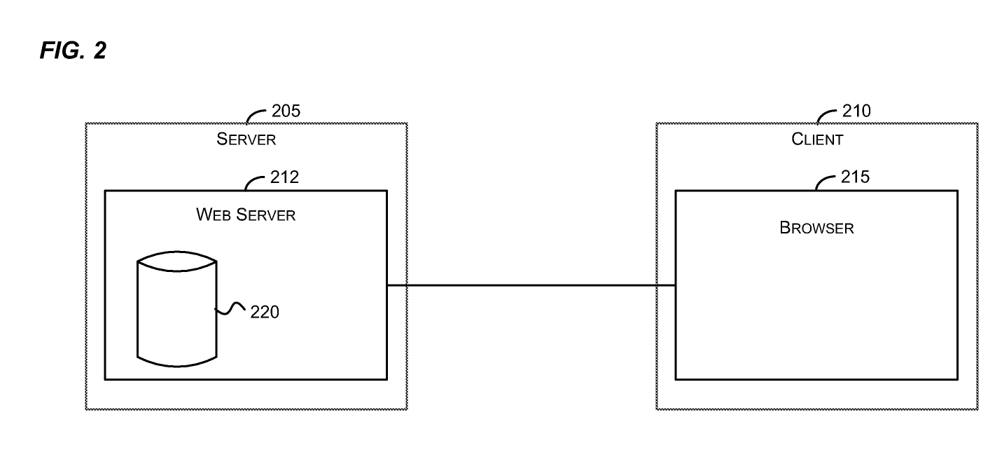

As mentioned previously, creating tools that allow a software developer to seamlessly create the server code corresponding to a Web page is challenging. FIG. 2 is a block diagram that generally represents an exemplary environment in which aspects of the subject matter described herein may be implemented. The environment may include a server 205 a client 210, and other entities (not shown).

The server 205 and the client 210 may be implemented on or as one or more computers (e.g., the computer 110 as described in conjunction with FIG. 1). Although the terms “client” and “server” are sometimes used herein, it is to be understood, that a client may be implemented on a machine that has hardware and/or software that is typically associated with a server and that likewise, a server may be implemented on a machine that has hardware and/or software that is typically associated with a desktop, personal, or mobile computer. Furthermore, a client may at times act as a server and vice versa. At times, two or more entities that more frequently act as a client or server may concurrently be peers, servers, or clients. In an embodiment, a client and server may be implemented on the same physical machine.

Furthermore, as used herein, each of the terms “server” and “client” may refer to one or more physical or virtual entities, one or more processes executing on one or more physical or virtual entities, and the like. Thus, a server may include an actual physical node upon which one or more processes execute, a virtual node upon which one or more processes execute, a service executing on one or more nodes, a group of nodes that together provide a service, and the like. A service may include one or more processes executing on one or more physical or virtual entities. Furthermore, a single process may implement one or more servers.

The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or located on a single device.

The server 205 may host a Web server 212 for providing Web pages to clients. The Web server 212 may locate data corresponding to Web pages on a store 220 accessible to the Web server 212. For security reasons, the client 210 may have components that restrict the activities of the browser 215. For example, it may not be desirable for the browser to be able to load and execute code that is not contained in a page requested by the browser 215.

When the browser 215 requests the content of a Web page, the server 205 may generate code that when rendered on the client may display the requested Web page. In generating code for a control or other part of the page, the server 205 may be referred to additional data such as data referenced by a URL. For example, in the .NET Framework, a Web part may be created by loading a control in the Web part where the code for the control is referenced in a URL.

A Web part is code that may modify the content, appearance, or behavior of a Web page. A Web part may be thought of as a software widget that may operate dependently or independently of the other content of the Web page. For example, an ad widget may retrieve ads based on content of the page. As another example, a weather widget may display the weather for a part of the country. As another example, a stock market widget may display current or delayed stock market prices.

For some Web servers, loading code from outside of a page may violate security policy and may not be allowed. On these Web servers a Web part that obtains code from one or more other URLs may not execute correctly. In some environments, only Web administrators may deploy certain controls such as user controls, whereas others without admin rights may deploy other controls such as sandboxed Web parts.

To overcome these and other problems, the code of a Web part may be encoded directly into the page or into an assembly trusted by the Web server. For example, a developer seeking to develop a Web part may create code that, when executed by a Web server, emits code that when rendered on a client displays the Web part. As will be appreciated by those skilled in the art, manually creating the code for a Web part is tedious and time consuming.

In one embodiment, a visual design tool may operate directly with Web parts. The visual design tool may allow a software developer to place a representation of a Web part on a design Web page in a GUI development environment. The tool may also allow the software developer to create code to handle certain events of the Web part. The tool may generate the appropriate code and place the code in an assembly or other code unit such that the code does not violate security principles of a given platform or server.

In another embodiment, code generated from an existing tool may be transformed into code suitable for deploying as a Web part on a Web server. For example, a development environment may include a tool that allows a user to develop user controls. Such a tool, for example, may generate markup language statements and code of another language (e.g., C#, C++, another programming language, or the like). The output from such a tool may not be suitable for direct inclusion into the Web part. In this case, the code may be transformed into a form suitable for inclusion in a Web part.

In one embodiment, this transformation may include the following actions:

1. During design time, a developer may create a control in a GUI designer of a development environment. The developer may indicate that the control is to be transformed into a Web part. For example, to indicate that the control is to be transformed into a Web part, the developer may associate the control with a Web part, check a box, or make some other indication.

2. When the developer creates a control, markup language code corresponding to the control may be generated. For example, in the .NET framework, code such as the following may be generated:

<%@ Assembly Name=“$SharePoint.Project.AssemblyFullName$” %>
<%@ Assembly Name=“Microsoft.Web.CommandUI, Version=14.0.0.0,
Culture=neutral, PublicKeyToken=71e9bce111e9429c” %>
<%@ Register Tagprefix=“SharePoint”
Namespace=“Microsoft.SharePoint.WebControls”
Assembly=“Microsoft.SharePoint, Version=14.0.0.0,
Culture=neutral, PublicKeyToken=71e9bce111e9429c” %>
<%@ Register Tagprefix=“Utilities”
Namespace=“Microsoft.SharePoint.Utilities”
Assembly=“Microsoft.SharePoint, Version=14.0.0.0,
Culture=neutral, PublicKeyToken=71e9bce111e9429c” %>
<%@ Register Tagprefix=“asp” Namespace=“System.Web.UI”
Assembly=“System.Web.Extensions, Version=3.5.0.0,
Culture=neutral, PublicKeyToken=31bf3856ad364e35” %>
<%@ Import Namespace=“Microsoft.SharePoint” %>
<%@ Register Tagprefix=“WebPartPages”
Namespace=“Microsoft.SharePoint.WebPartPages”
Assembly=“Microsoft.SharePoint, Version=14.0.0.0,
Culture=neutral, PublicKeyToken=71e9bce111e9429c” %>
<%@ Control Language=“C#” AutoEventWireup=“true”
CodeBehind=“VisualWebPart1UserControl.ascx.cs”
Inherits=“VisualWebPartProject2.VisualWebPart1.VisualWebPart1U
serControl” %>
<asp:Button ID=“Button1” runat=“server” Text=“Refresh” />

Note that the code above is not intended to be all-inclusive or exhaustive or code that may be generated. Rather, it is intended to serve as one example of code that may be generated when creating a user control that contains a button control for its only child. Those skilled in the art will recognize other code that may be generated for other controls without departing from the spirit or scope of aspects of the subject matter described herein. The code above may be placed into a file (e.g., such as an ACSX file) of a project used for a Web site. The code above corresponds to markup code a Web server may obtain prior to generating client code for the control.

To get the source code corresponding to the above code a method (e.g., System.Web.Compilation) may be called in a development environment. Appendix A provides an example of source code that may be generated in response to the code above.

3. The markup language corresponding to the control may be used to generate source code corresponding to the control. For example, through a library (e.g., System.Web.Compilation), the code of Appendix A may be generated prior to a client requesting a page that includes the control.

In generating the source code corresponding to the control, a compiler may pass through various activities. In a first activity, the compiler may parse the markup language code file. Using this file, the compiler may generate a data structure such as a document object model tree in memory for a language-agnostic model of the source code. After generating this tree, the compiler may compile the source code into an assembly.

4. To capture this source code prior to it being compiled, the compiler may be referred to a code provider. The compiler may pass the code provider the data structure. The code provider may manipulate the data structure to modify nodes of the data structure. For example, the code provider may change the inheritance hierarchy of classes.

Changing the inheritance of a class may be done, for example, to use the source code of a class (e.g., a user control) supported by a visual design tool to create source code for a class (e.g., a Web part) that is not supported by the visual design tool. When the inheritance is changed, however, some other code of the source code may also need to be changed to make it appropriate for the target class.

For example, the code provider may remove or modify an override call. For example, a child class such as a user control may have its parent changed to that of a Web part. In this inheritance change, override calls present in the child class may need to be changed to override methods of the parent class or removed. For example, if the new parent class has a similar functioning but differently named override method, a name substitution may be made. As another example, if there is no similar override function in the new parent class, the override call may be deleted altogether.

As another example, the code provider may add initialization code. For example, when inheritance is changed from a user control to a Web part, the control may need to have different initialization.

As another example, the namespace of the control may need to be changed. Each of the changes above may be made by modifying the data structure. As the data structure is language-agnostic, source code for another language may be generated from the data structure.

5. After the changes have been made to the data structure, the data structure may be passed to a component that converts the data structure into source code of a target language. Appendix B provides an example of a target source code that may be generated in response to the source code illustrated in Appendix A.

6. To avoid completing the compilation process and creating an assembly, the compilation may be aborted. One mechanism for doing this is to throw an exception in the code provider while passing the source code to a component that will insert the source code into the project.

7. The source code may then be inserted into a project as a partial class. Doing this allows a developer to modify a user modifiable portion of the partial class without interfering with the work done by the development tool. In addition, when the project is compiled into an assembly, the source code is also compiled into the assembly.

As an example, in the .NET framework, the above may be accomplished by providing a configuration file that has modified CodeGenerator settings for the C# and VB.NET languages. When the ASP.NET compiler gets to the code generation phase, it calls into the provided classes and passes a Code Document Object Model (CodeDOM) tree as a parameter. The CodeDOM tree may then be manipulated to make the changes above. After the CodeDOM tree has been manipulated, it is passed to a code generator that generates the source code from the modified CodeDOM tree. This source code is then inserted into the project as the code corresponding to a Web part.

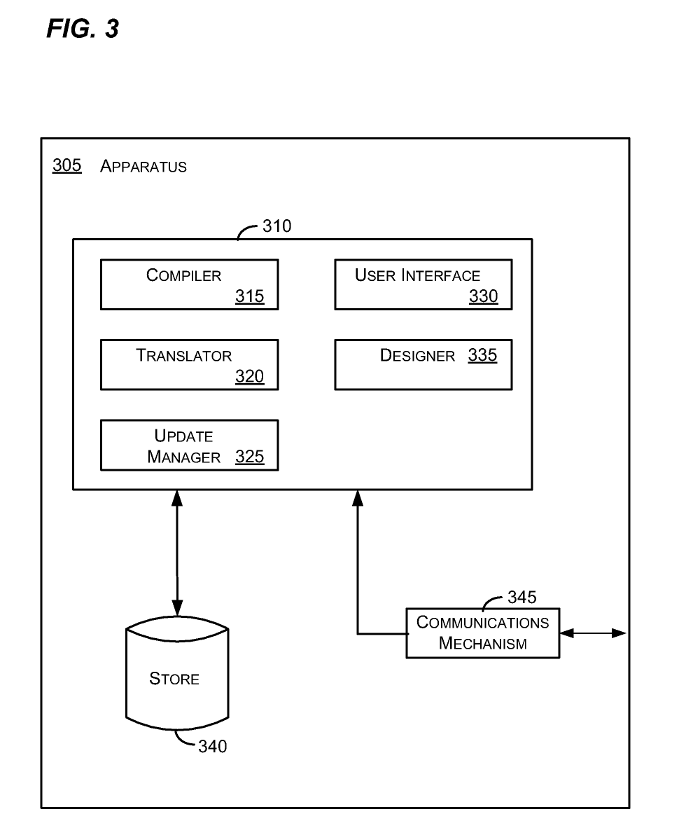

FIG. 3 is a block diagram that represents an apparatus configured to operate as a software development platform in accordance with aspects of the subject matter described herein. The components illustrated in FIG. 3 are exemplary and are not meant to be all-inclusive of components that may be needed or included. In other embodiments, the components and/or functions described in conjunction with FIG. 3 may be included in other components (shown or not shown) or placed in subcomponents without departing from the spirit or scope of aspects of the subject matter described herein. In some embodiments, the components and/or functions described in conjunction with FIG. 3 may be distributed across multiple devices. The components of FIG. 3 may be implemented by or executed by a processor such as the processing unit 120 of FIG. 1.

Turning to FIG. 3, the apparatus 305 may include development components 310, a store 340, a communications mechanism 345, and other components (not shown). The apparatus 305 may comprise one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as the apparatus 305 comprises the computer 110 of FIG. 1.

The communications mechanism 345 allows the apparatus 305 to communicate with other entities. For example, the communications mechanism 345 may allow the apparatus 305 to communicate with a server that host server software projects. The communications mechanism 345 may be a network interface or adapter 170, modem 172, or any other mechanism for establishing communications as described in conjunction with FIG. 1.

The store 340 is any storage media capable of providing access to data associated with software development. Access as used herein may include reading data, writing data, deleting data, updating data, a combination including two or more of the above, and the like. The store 340 may comprise a file system, database, volatile memory such as RAM, other storage, some combination of the above, and the like and may be distributed across multiple devices. The store 340 may be external, internal, or include components that are both internal and external to the apparatus 305.

The development components 310 may include a compiler 315, a translator 320, an update manager 325, a user interface 330, and other components (not shown). As used herein, the term component is to be read to include all or a portion of a device, a collection of one or more software modules or portions thereof, some combination of one or more software modules or portions thereof and one or more devices or portions thereof, and the like.

The compiler 315 may parse a markup language code file corresponding to a control, generate a data structure that represents the source code of the control, and pass this data structure to the translator 320 (e.g., a provider). The compiler 315 may also create an assembly from various code units of a project.

The translator 320 may be operable to receive a data structure that represents the control and change the data structure as appropriate to create code for a target. For example, the translator 320 may change inheritance of a class of the control and make other changes to the class as appropriate for the change in inheritance as described previously. For example the translator 320 may modify the data structure to delete an override statement that is no longer applicable when the inheritance of the class is changed. As another example, the translator 320 may modify the data structure to change a namespace of the data structure.

The update manager 325 may be operable to determine whether to generate source code corresponding to the control. The update manager 325 may determine to update the source code based on various events. For example, when a software developer makes a change to the control, the update manager 325 may wait until a window showing the source code of the control is viewable before updating the source code. As another example, when the project is saved, compiled, or executed, the update manager 325 may initiate the actions that transform the source code of the control.

The user interface 330 is operable to display a graphical representation of a control and to receive user design input regarding the control. A control may include an object that has a visual representation in the development environment.

The designer 335 is operable to receive design information regarding a control. Design information may include code, placement, properties, other data, and the like. The designer 335 may be further operable to generate markup language code that represents the control to a server capable of hosting a Web page that includes the control.

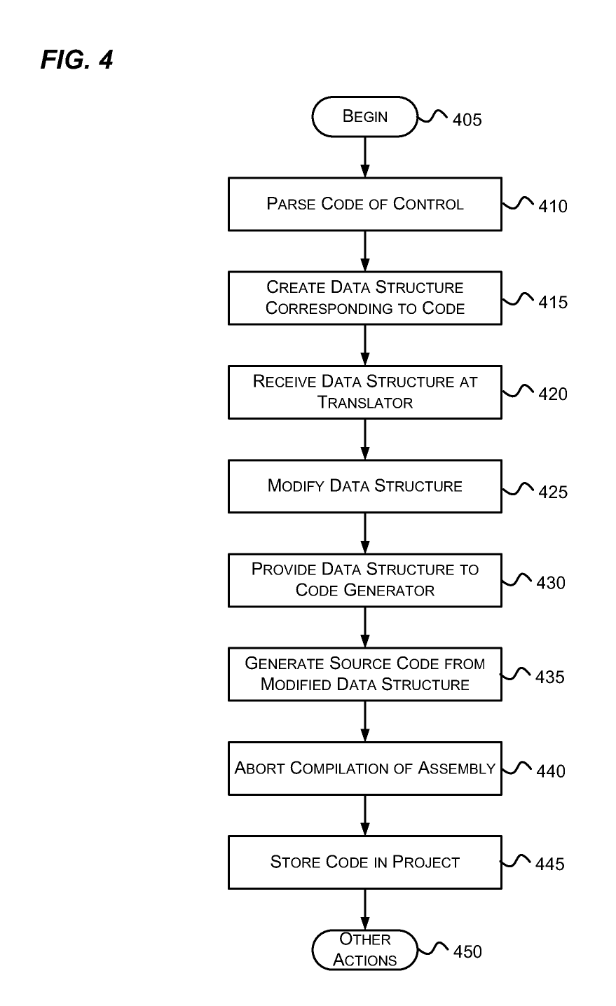

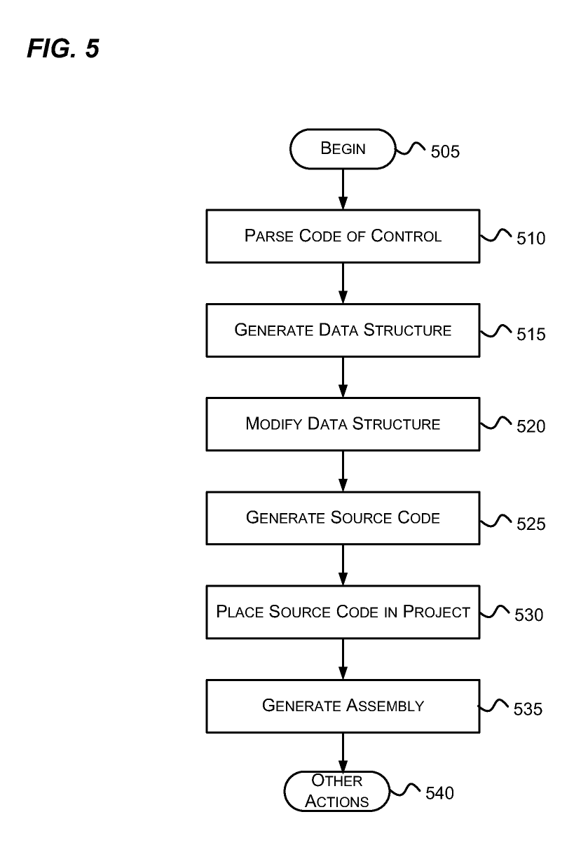

FIGS. 4-5 are flow diagrams that generally represent actions that may occur in accordance with aspects of the subject matter described herein. For simplicity of explanation, the methodology described in conjunction with FIGS. 4-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin. For example, referring to FIG. 3, the update manager 325 may determine that source code for a control is to be generated.

At block 410, code of the control may be parsed. For example, referring to FIG. 3, the compiler 315 may parse markup language code corresponding to the control. One example of such markup language code has been provided above.

At block 415, a data structure corresponding to the code is created. For example, referring to FIG. 3, the compiler 315 may create a tree data structure corresponding to source code of the control. The tree data structure may correspond to a document object model of the source code.

At block 420, the data structure is received at a translator. For example, referring to FIG. 3, the translator 320 receives the data structure passed by the compiler 315.

At block 425, the data structure is modified. For example, referring to FIG. 3, the translator 320 may modify the data structure to cause a child class to inherit from a different parent class instead of the parent class it originally inherited from. In addition, the translator 320 may modify the data structure to change a namespace, add initialization code, remove an override call where the override call references a method of the first parent that does not exist in the new parent, may make other changes as mentioned previously, and the like.

At block 430, the data structure is provided to a code generator. For example, referring to FIG. 310, the translator 320 may call a code generator and pass the data structure thereto. In one embodiment, the code generator may be a method of an instance of a compiler.

At block 435, source code is generated from the modified data structure. This source code may include server instructions for generating code to provide to a client such as a Web browser that has requested a page from the server.

At block 440, compilation of the assembly is optionally aborted. For example, referring to FIG. 3, the translator may throw an exception to stop the compilation process.

At block 445, the code is stored in a project. For example, referring to FIG. 3, one of the development components 310 may place the code in a project. At the same time, the component may refrain from putting markup code from which the source code was derived into the project. As mentioned previously, the code may be placed in a partial class. The partial class may include a portion designated (e.g., via comments) as modifiable and a portion designated as auto-generated. As indicated earlier, the modifiable portion may be safely modified by a developer while the auto-generated portion may be changed as the control is changed.

At block 450, other actions, if any, may be performed.

Turning to FIG. 5, at block 505, the actions begin. For example, referring to FIG. 3, the update manager 325 may determine that source code for a control is to be generated.

At block 510, code of the control may be parsed. The code of the control may be represented at least in part via a markup language. For example, referring to FIG. 3, the compiler 315 may parse markup language code corresponding to the control.

At block 515, a data structure that represents server code of the control may be generated. For example, referring to FIG. 3, the compiler 315 may create a tree data structure corresponding to source code of the control.

At block 520, the data structure is modified. For example, referring to FIG. 3, the translator 320 may modify the data structure to cause a child class to inherit from a different parent class instead of the parent class it originally inherited from. In addition, the translator 320 may also make other modifications as described previously.

At block 525, the source code from the data structure as modified is generated. This source code may be in a language other than the markup language originally representing the control.

At block 530, the source code is placed in a project. For example, referring to FIG. 3, one of the development components 310 may place the code in the project.

At block 535, an assembly derived at least in part from the source code may be generated. For example, referring to FIG. 3, in response to a compilation request received by the user interface 330, a project may be compiled and deployed to a server.

At block 540, other actions, if any, may be performed.

As can be seen from the foregoing detailed description, aspects have been described related to converting controls into source code. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

Appendix A

#pragma checksum “C:\Program Files\Common Files\Microsoft Shared\Web Server

Extensions\14\template\controltemplates\VisualWebPartProject2\VisualWebPart1\VisualWe
bPart1UserControl.ascx” “{406ea660-64cf-4c82-b6f0-42d48172a799}”
“663860B46B458B40CE329499C9EC66C6”

| //------------------------------------------------------------------------------ | |
|---|---|
| // <auto-generated> | |
| // | This code was generated by a tool. |
| // | Runtime Version:2.0.50727.4927 |
| // | |
| // | Changes to this file may cause incorrect behavior and will be lost if |
| // | the code is regenerated. |

// </auto-generated>
//------------------------------------------------------------------------------
namespace ASP {

#line 281 “C:\Windows\Microsoft.NET\Framework64\v2.0.50727\Config\web.config”
using System.Web;
#line default
#line hidden
#line 280 “C:\Windows\Microsoft.NET\Framework64\v2.0.50727\Config\web.config”
using System.Text.RegularExpressions;
#line default
#line hidden
#line 7 “C:\Program Files\Common Files\Microsoft Shared\Web Server

Extensions\14\template\controltemplates\VisualWebPartProject2\VisualWebPart1\VisualWe
bPart1UserControl.ascx”

using Microsoft.SharePoint.WebPartPages;
#line default
#line hidden
#line 3 “C:\Program Files\Common Files\Microsoft Shared\Web Server

Extensions\14\template\controltemplates\VisualWebPartProject2\VisualWebPart1\VisualWe
bPart1UserControl.ascx”

using Microsoft.SharePoint.WebControls;
#line default
#line hidden
#line 284 “C :\Windows\Microsoft.NET\Framework64\v2.0.50727\Config\web.config”
using System.Web.Security;
#line default
#line hidden
#line 4 “C:\Program Files\Common Files\Microsoft Shared\Web Server

Extensions\14\template\controltemplates\VisualWebPartProject2\VisualWebPart1\VisualWe
bPart1UserControl.ascx”

using Microsoft.SharePoint.Utilities;
#line default
#line hidden
#line 275 “C:\Windows\Microsoft.NET\Framework64\v2.0.50727\Config\web.config”
using System;
#line default
#line hidden
#line 276 “C:\Windows\Microsoft.NET\Framework64\v2.0.50727\Config\web.config”
using System.Collections;
#line default
#line hidden
#line 277 “C:\Windows\Microsoft.NET\Framework64\v2.0.50727\Config\web.config”
using System.Collections.Specialized;
#line default
#line hidden
#line 6 “C:\Program Files\Common Files\Microsoft Shared\Web Server

Extensions\14\template\controltemplates\VisualWebPartProject2\VisualWebPart1\VisualWe
bPart1UserControl.ascx”

using Microsoft.SharePoint;
#line default
#line hidden
#line 5 “C:\Program Files\Common Files\Microsoft Shared\Web Server

Extensions\14\template\controltemplates\VisualWebPartProject2\VisualWebPart1\VisualWe
bPart1UserControl.ascx”

using System.Web.UI;
#line default
#line hidden
#line 285 “C:\Windows\Microsoft.NET\Framework64\v2.0.50727\Config\web.config”
using System.Web.Profile;
#line default
#line hidden
#line 279 “C:\Windows\Microsoft.NET\Framework64\v2.0.50727\Config\web.config”
using System.Text;
#line default
#line hidden
#line 282 “C:\Windows\Microsoft.NET\Framework64\v2.0.50727\Config\web.config”
using System.Web.Caching;
#line default
#line hidden
#line 5 “C:\Program Files\Common Files\Microsoft Shared\Web Server

Extensions\14\template\controltemplates\VisualWebPartProject2\VisualWebPart1\VisualWe
bPart1UserControl.ascx”

using System.Web.UI.WebControls;
#line default
#line hidden
#line 278 “C:\Windows\Microsoft.NET\Framework64\v2.0.50727\Config\web.config”
using System.Configuration;
#line default
#line hidden
#line 5 “C:\Program Files\Common Files\Microsoft Shared\Web Server

Extensions\14\template\controltemplates\VisualWebPartProject2\VisualWebPart1\VisualWe
bPart1UserControl.ascx”

using System.Web.UI.WebControls.WebParts;
#line default
#line hidden
#line 283 “C:\Windows\Microsoft.NET\Framework64\v2.0.50727\Config\web.config”
using System.Web.SessionState;
#line default
#line hidden
#line 289 “C:\Windows\Microsoft.NET\Framework64\v2.0.50727\Config\web.config”
using System.Web.UI.HtmlControls;
#line default
#line hidden
[System.Runtime.CompilerServices.CompilerGlobalScopeAttribute( )]
public class

_controltemplates_visualwebpartproject2_visualwebpart1_visualwebpart1usercontrol_ascx :
global::VisualWebPartProject2.VisualWebPart1.VisualWebPart1UserControl {

private static bool @_{——}initialized;
[System.Diagnostics.DebuggerNonUserCodeAttribute( )]
public

_controltemplates_visualwebpartproject2_visualwebpart1_visualwebpart1usercontrol_ascx( )
{
((global::VisualWebPartProject2.VisualWebPart1.VisualWebPart1UserControl)(this)).AppR
elativeVirtualPath =
“~/_CONTROLTEMPLATES/VisualWebPartProject2/VisualWebPart1/VisualWebPart1User
Contro” +

“l.ascx”;

if

((global::ASP._controltemplates_visualwebpartproject2_visualwebpart1_visualwebpart1user
control_ascx.@_{——}initialized == false)) {
global::ASP._controltemplates_visualwebpartproject2_visualwebpart1_visualwebpart1userco
ntrol_ascx.@_{——}initialized = true;

}

}
protected System.Web.Profile.DefaultProfile Profile {

get {

return ((System.Web.Profile.DefaultProfile)(this.Context.Profile));

}

}
protected ASP.global_asax ApplicationInstance {

get {

return ((ASP.global_asax)(this.Context.ApplicationInstance));

}

}
[System.Diagnostics.DebuggerNonUserCodeAttribute( )]
private global::System.Web.UI.WebControls.Button @_{——}BuildControlButton1( ) {

global::System.Web.UI.WebControls.Button @_{——}ctrl;
#line 9 “C:\Program Files\Common Files\Microsoft Shared\Web Server

Extensions\14\template\controltemplates\VisualWebPartProject2\VisualWebPart1\VisualWe
bPart1UserControl.ascx”

@_{——}ctrl = new global::System.Web.UI.WebControls.Button( );
#line default
#line hidden
this.Button1 = @_{——}ctrl;
@_{——}ctrl.ApplyStyleSheetSkin(this.Page);
#line 9 “C:\Program Files\Common Files\Microsoft Shared\Web Server

Extensions\14\template\controltemplates\VisualWebPartProject2\VisualWebPart1\VisualWe
bPart1/UserControl.ascx”

@_{——}ctrl.ID = “Button1”;
#line default
#line hidden
#line 9 “C:\Program Files\Common Files\Microsoft Shared\Web Server

Extensions\14\template\controltemplates\VisualWebPartProject2\VisualWebPart1\VisualWe
bPart1UserControl.ascx”

@_{——}ctrl.Text = “Refresh”;
#line default
#line hidden
return @_{——}ctrl;

}
[System.Diagnostics.DebuggerNonUserCodeAttribute( )]
private void

@_{——}BuildControlTree(_controltemplates_visualwebpartproject2_visualwebpart1_visualwebp
art1usercontrol_ascx @_{——}ctrl) {

global::System.Web.UI.WebControls.Button @_{——}ctrl1;
#line 1 “C:\Program Files\Common Files\Microsoft Shared\Web Server

Extensions\14\template\controltemplates\VisualWebPartProject2\VisualWebPart1\VisualWe
bPart1UserControl.ascx”

@_{——}ctrl1 = this.@_{——}BuildControlButton1( );
#line default
#line hidden
System.Web.UI.IParserAccessor @_{——}parser =

((System.Web.UI.IParserAccessor)(@_{——}ctrl));

#line 1 “C:\Program Files\Common Files\Microsoft Shared\Web Server

Extensions\14\template\controltemplates\VisualWebPartProject2\VisualWebPart1\VisualWe
bPart1UserControl.ascx”

@_{——}parser.AddParsedSubObject(@_{——}ctrl1);
#line default
#line hidden
#line 1 “C:\Program Files\Common Files\Microsoft Shared\Web Server

Extensions\14\template\controltemplates\VisualWebPartProject2\VisualWebPart1\VisualWe
bPart1UserControl.ascx”

@_{——}parser.AddParsedSubObject(new System.Web.UI.LiteralControl(“\r\n”));
#line default
#line hidden

}
[System.Diagnostics.DebuggerNonUserCodeAttribute( )]
protected override void FrameworkInitialize( ) {

base.FrameworkInitialize( );
this.@_{——}BuildControlTree(this);

}

}

}

Appendix B

| //------------------------------------------------------------------------------ | |
|---|---|
| // <auto-generated> | |
| // | This code was generated by a tool. |
| // | Runtime Version:4.0.30111.0 |
| // | |
| // | Changes to this file may cause incorrect behavior and will be lost if |
| // | the code is regenerated. |

// </auto-generated>
//------------------------------------------------------------------------------
namespace VisualWebPartProject2.VisualWebPart1 {

using System.Web;
using System.Text.RegularExpressions;
using Microsoft.SharePoint.WebPartPages;
using Microsoft.SharePoint.WebControls;
using System.Web.Security;
using Microsoft.SharePoint.Utilities;
using System.Web.UI;
using System;
using System.Web.UI.WebControls;
using System.Collections.Specialized;
using Microsoft.SharePoint;
using System.Collections;
using System.Web.Profile;
using System.Text;
using System.Web.Caching;
using System. Configuration;
using System.Web.UI.WebControls.WebParts;
using System.Web.SessionState;
using System.Web.UI.HtmlControls;
public partial class VisualWebPart1UserControl {

[global::System.ComponentModel.EditorBrowsableAttribute(global::System.ComponentMo
del.EditorBrowsableState.Never)]

protected global::System.Web.UI.WebControls.Button Button1;

[global::System.ComponentModel.EditorBrowsableAttribute(global::System.ComponentMo
del.EditorBrowsableState.Never)]

private global::System.Web.UI.WebControls.Button @_{——}BuildControlButton1( ) {

global::System.Web.UI.WebControls.Button @_{——}ctrl;
@_{——}ctrl = new global::System.Web.UI.WebControls.Button( );
this.Button1 = @_{——}ctrl;
@_{——}ctrl.ApplyStyleSheetSkin(this.Page);
@_{——}ctrl.ID = “Button1”;
@_{——}ctrl.Text = “Refresh”;
return @_{——}ctrl;

}

[global::System.ComponentModel.EditorBrowsableAttribute(global::System.ComponentMo
del.EditorBrowsableState.Never)]

private void

@_{——}BuildControlTree(global::VisualWebPartProject2.VisualWebPart1.VisualWebPart1User
Control @_{——}ctrl) {

global::System.Web.UI.WebControls.Button @_{——}ctrl1;
@_{——}ctrl1 = this.@_{——}BuildControlButton1( );
System.Web.UI.IParserAccessor @_{——}parser =

((System.Web.UI.IParserAccessor)(@_{——}ctrl));

@_{——}parser.AddParsedSubObject(@_{——}ctrl1);

}
private void InitializeControl( ) {

this.@_{——}BuildControlTree(this);
this.Load += new global::System.EventHandler(this.Page_Load);

}

}

}

What is claimed is:

1. A method implemented at least in part by a computer, the method comprising:
receiving a data structure that corresponds to server code of a control, the server code including instructions for generating client code corresponding to the control, the data structure including a child class that inherits from a first parent class;
modifying the data structure at least by causing the child class to inherit from a second parent class instead of the first parent class;
providing the data structure as modified to a code generator; and
generating source code from the data structure as modified, the source code including server instructions for generating code to provide to a client.

2. The method of claim 1, wherein receiving a data structure that corresponds to server code of a control comprises receiving a tree data structure that corresponds to a document object model of the server code.

3. The method of claim 1, further comprising parsing markup language code corresponding to the control to generate the data structure.

4. The method of claim 1, further comprising storing the source code in a partial class, the partial class having a portion designated as modifiable and a portion designated as auto-generated.

5. The method of claim 4, further comprising adding a statement in the portion designated as modifiable to call initialization code in the portion designated as auto-generated.

6. The method of claim 1, further comprising modifying the data structure to remove an override call, the override call referencing a method of the first parent that does not exist in the second parent.

7. The method of claim 1, further comprising modifying the data structure to change a namespace of the data structure.

8. The method of claim 1, further comprising aborting creation of an assembly derived at least in part from the source code.

9. The method of claim 1, further comprising inserting the source code into a project that includes files related to a Web site and refraining from placing markup code for the control in the project.

10. A computer storage medium having computer-executable instructions, which when executed perform actions, comprising:
parsing markup code for a control that is represented at least in part via a markup language;
generating a data structure that represents server code of the control;
modifying the data structure at least to change inheritance of a class of the server code;
generating source code from the data structure as modified, the source code in a language other than the markup language; and
placing the source code in a project.

11. The computer storage medium of claim 10, wherein placing the source code in a project comprises placing the source code in a partial class, the partial class having a portion designated as modifiable and a portion designated as auto-generated.

12. The computer storage medium of claim 11, further comprising indicating via text inserted in the portion designated as auto-generated that the portion designated as auto-generated may be regenerated.

13. The computer storage medium of claim 10, further comprising generating an assembly that is derived at least in part from the source code, the assembly, when executed, generating code to supply to a client to implement functionality of the control via an Internet browser of the client.

14. In a computing environment, an apparatus, comprising:
a user interface operable to display a graphical representation of a control;
a designer operable to receive design information regarding the control;
a update manager operable to determine whether to generate source code corresponding to the control; and
a translator operable to receive a data structure that represents the control and to at least change, in the data structure, inheritance of a class of the control.

15. The apparatus of claim 14, wherein the designer is further operable to generate markup language code that represents the control to a server capable of hosting a Web page that includes the control.

16. The apparatus of claim 14, wherein the data of the control comprises source code and properties of the control.

17. The apparatus of claim 14, wherein the translator being operable to receive a data structure that represents the control comprises the translator being operable to receive a tree data structure that represents source code of the control.

18. The apparatus of claim 14, wherein the update manager being operable to determine whether to generate source code corresponding to the control comprises the generation manager determining whether a change has occurred to the control.

19. The apparatus of claim 14, wherein the translator is further operable to modify the data structure to delete an override statement that is no longer applicable when the inheritance of the class is changed.

20. The apparatus of claim 14, wherein the translator is further operable to modify the data structure to change a namespace of the data structure, namespace including the class after the inheritance of the class is changed.
